(19) United States
(12) Patent Application Publication
(10) Pub. No.: US 2006/0026160 A1
(43) Pub. Date: Feb. 2, 2006

(54) Handheld network connection created with storage media in a pocket format

(76) Inventor: Dan Bertil Duroj, Bandhagen (SE)

Correspondence Address: Deborah Neville, PO Box 61063, Palo Alto, CA, 94306, US

(21) Appl. No.: 10/535,743

(22) PCT Filed: Jul. 13, 2004
(86) PCT No.: PCT/SE04/01131

§ 371 Date: May 20, 2005

(30) Foreign Application Priority Data
Aug. 11, 2003 (SE) 0302189-6

(51) Int. Cl. G06F 17/30

(52) U.S. Cl. 707/10

(57) ABSTRACT

The invention relates to a handheld network connection and a method therefore, created with at least two storage media (24, 26, 28) in pocket format, with software for communication of data packets between at least two networks (10, 12, 14) access blockages of the type of at least one of a firewall (20), socks, IP-filter and proxy. Each of the storage media (24, 26, 28) having an interface to a host computer (29) in the networks (10, 12, 14), and which through software establishes communication with the host computer (29) within the networks (10, 12, 14) by utilizing the host computers (29) temporary catalogues, which provides access to the host computer (29) without disturbing its file structure. A crypto-daemon according to the invention comprises a connecting methodic testing to establish a tunneling (32) to an external central server (30) regarding the type of the allowable data packets for communication towards the existing type of access blockage, the crypto-daemon establishing the tunneling towards the external central server (30) passing the access blockage. Through the invention, an external network is established through the external central server (30) outside the networks for simultaneous communication through at least two storage media (24, 26, 28) and their software, the tunneling (32) through the access blockage being provided without trespassing the networks (10, 12, 14) per se, conveying towards the access blockage unrestricted capacity for the communication of data packets.

### TECHNICAL FIELD

The present invention pertains to a handheld network connection created with at least two storage media in pocket format, with software for communication of data packets between at least two network access blockages of the type of at least one of a firewall, socks, IP-filter or proxy. The invention also comprises a method therefore.

### BACKGROUND ART

In the absence of a simple platform for handling of distribution and network communication and storing of data, for an ordinary skilled user of a computer, is a limiting factor in the current IT society. The IT commission states that it is too complicated to utilize Internet, and due to this fact there is going to be at least two classes of users, they who are educated to utilize Internet, and those who are not. Enterprises and private persons transmit, store, and work with ever bigger files utilizing networks. In order to cope with this, software as e-mail, FTP, http based web interfaces and VPN solutions are utilized.

A number of problems arise to the ordinary skilled user of computers. All PC based computers sooner or later fail to work, which leads to the loss of personal and company valuables, having for instance the consequence that a backup is missing and empty. Storing of data at home and at work is for different reasons compromised by eavesdropping and access by none authorized, which leads to demands for encrypted safe storing of data. Employed and private persons sometimes are prone to distribute files with the size of 1 GB. This is in practice impossible for a person lacking education in IT to cope with, which promotes the transmitting of data through the aid of CD disks, diskettes, pocket memories and the like.

The ability of being able to switch between different working groups, enterprise, home, and spare time, thus always being able to have access to data files is one of the prime aspects of Internet related performances. In principle, this kind of activity is always closed, as enterprises control access and fear of infringement by closing down ports in firewalls, proxies, and IP-filters. This leads to that only public channels are available for the enterprise, such as http, e-mail, newsgroups or the like. This development has the consequence that a multiple of files are transmitted through http in place of FTP, and where a multiple of services are forced to survive in the HTML format through public browsers, when they de facto are of a private nature, i.e., enterprise to enterprise, person to person, bid and accept methods.

There exist concurrent systems such as e-mail. An e-mail administrator conventionally does not distribute more than 2 to 5 MB space an account. If further memory is needed the costs will rise substantially. Current e-mail clients download information during access, which means that sites having a low bandwidth, a large e-mail would block access to e-mail for a longer period.

Traditionally FTP is a tool to the educated administrator and it demands:
1. Deeper knowledge about networks.
2. Knowledge about the IP-/name address.
3. Software installed both at the own computer and at the receiver of files.

Http based network web-interfaces, which are accessed from for instance www.projektplatsen.se (projectplatsen=project site, freely translated) HOME SE Xdrive.com provide that:
1. The software has to be installed on the own computer.
2. The software is run through commercial web-browsers.
3. The security is not better than by conventional public web-reading, i.e., Explorer Netscape® 128 bits web-reading encryption.
4. It is complicated to share files with others.
5. It is not possible to review documents directly in the interface.
6. Advertisement is received through the web-reader, cookies, JavaScript and Exml programs are installed without being noticed on own computer.

So called peer-to-peer communication is a model which depends on that an anonymous user is prepared to distribute files and to up let a part of there own computer to unknown users in an anonymous network.

Problems with VPN arise when it:
1. Requires installation with a restricted number users of desk-board computers.
2. It is possible to download through a web-interface, but is then painfully slow and awkward.
3. In order to be able to work with mobility, it requests that the user has to bring along the computer on which the software is installed, and that the enterprise or network in which work is accomplished has allowed the connection of the computer in that environment.

HDD on USB and HDD on PCMCIA induces problems in that files are stored on the card/key, and not on the server. If the card/key is lost, the files are lost.

### SUMMARY OF THE INVENTION

To be able to solve problems according to the above and others, the present invention sets forth a handheld network connection created with at least two storage media in pocket format, with software for communication of data packets between at least two network access blockages of the type of at least one of a firewall, socks, IP-filter and proxy. Each the storage media having an interface to a host computer in the networks, and which through software establishes communication with the host computer within the networks by utilizing the host computers temporary catalogues which provides access to the host computer without disturbing its file structure.

A crypto-daemon which comprises a connecting methodic testing to establish a tunneling to an external central server regarding the type of the allowable data packets for communication towards the existing type of access blockage, the crypto-daemon establishing the tunneling towards the external central server passing the access blockage through a test establishment of a communication with the access blockage, the connecting methodic adapting to the wanted type of data packets by repeatedly questioning the access blockage for the allowable type of data packages until the correct type is encountered by remembering and repeatedly disregarding wrong questionings, and at the correct questioning changing the structure of the data package to the wanted structure for the specific port at hand for a communication.

An external network is established through the external central server outside the networks for simultaneous communication through at least two storage media and their software, the tunneling through the access blockage being provided without trespassing the networks per se, conveying towards the access blockage unrestricted capacity for the communication of data packets.

An embodiment of the methodic addresses the following software expressed in pseudo code while accessing a determined port:

Check if proxy is to be utilized
If “OK”

Test HTTP-proxy
If “OK”

Connect through proxy

Else

Test SOCKS4-proxy
If “OK”

Connect through SOCKS4-proxy

Else

Test SOCKS5-proxy
If “OK”

Connect through SOCKS5-proxy

Else

Test direct connection
If “OK”

Provide direct connection

Else

Direct connection failure

Else

Test direct connection

If “OK”

Provide direct connection

Else

Connection failure or test a new port.

A further embodiment of the methodic comprises for a future generation of proxy/firewall, only letting through granted traffic is overruled/surrounded by hiding transmitted data through a dummy HTML page with the data masked.

In one embodiment accessible files through the host computer are accesed/fetched and encoded in the host computer temporary file catalogue, the files being stored encoded on the external central server, having a determined access profile allowing at least reading of the file but not copying from a computer outside the network with a connected host computer, thus allowing display of files outside the network.

Another embodiment comprises that the media user is allowed to freely move in a host network and to communicate externally through the external central server with other users of the media through the tunneling.

One embodiment includes that media software comprises IP-telephony, the user of the media from a computerized device of his choice in a network of his choice establishing spontaneous IP-telephony through the central server.

A further embodiment comprises that a creation of at least one of a radio channel and a film channel with/towards other users in the external network is enabled by the media software, comprising streaming media, the users thus being able to consume music and film.

Yet another embodiment includes media software comprising version handling, thus making possible to recreate earlier versions of files by saving changes in a separate memory in the external central server, being switched on/off through a server switch on the request of a user.

Yet a further embodiment comprises that media software enables multiple users of it to process a common text file in real time through the external central server.

Moreover, the present invention comprises a method for a handheld network connection created with at least two storage media in pocket format, with software for communication of data packets between at least two network access blockages of the type of at least one of a firewall, socks, IP-filter and proxy, comprising the steps of:
each the storage media having an interface to a host computer in the networks, and which through software establishes communication with the host computer within the networks by utilizing the host computers temporary catalogues which provides access to the host computer without disturbing its file structure;
having an access methodic comprised in a crypto-daemon testing to establish a tunneling to an external central server regarding the type of the allowable data packets for communication towards the existing type of access blockage, the crypto-daemon establishing the tunneling towards the external central server passing the access blockage through a test establishment of a communication with the access blockage, the connecting methodic adapting to the wanted type of data packets by repeatedly questioning the access blockage for the allowable type of data packages until the correct type is encountered by remembering and repeatedly disregarding wrong questionings, and at the correct questioning changing the structure of the data package to the wanted structure for the specific port at hand for a communication; and
whereby an external network is established through the external central server outside the networks for simultaneous communication through at least two storage media and their software, the tunneling through the access blockage being provided without trespassing the networks per se, conveying towards the access blockage unrestricted capacity for the communication of data packets.

Further method claims are defined by the attached sub method claims, as for their containment it is corresponding to the embodiments in accordance with the portable network connection.

### BRIEF DESCRIPTION OF THE DRAWINGS

Henceforth, reference is had to the attached drawings for a better understanding of the invention and its embodiments and given examples, wherein:

FIG. 1 schematically depicts how a communication is established between enterprise networks in accordance with prior art; and

FIG. 2 schematically depicts how a network connection is established via tunneling according to the present invention.

### DETAILED DESCRIPTION OF PREFERRED EMBODIMENTS

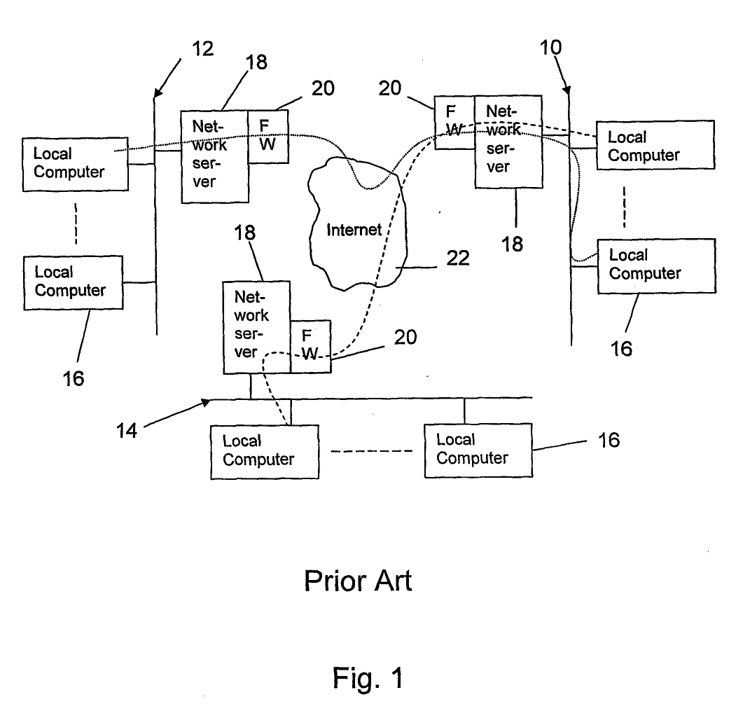

In FIG. 1 it is schematically depicted how a communication is established between enterprise/company networks 10, 12, 14 in accordance with prior art. Connected to the networks, LAN or the like are local computers 16. The broken line between local computers states that multiple computers could be connected to the networks 10, 12, 14. Networks 10, 12, 14 are controlled by network servers 18 in respectively each network. In order to establish a communication between for instance computers 16 in the networks 10, 12, 14, the networks access security/blockage for external traffic has to be enforced. The access protection/security is commonly performed by one or more firewalls, socks, IP-filter, or proxy, herein, in accordance with the embodiment of FIG. 1, exemplified through a firewall (FW, 20).

In the example according to FIG. 1 a packet data transmission is initiated via Internet 22 from a computer 16 in the network 12, dotted line in FIG. 1. Correspondingly, a communication is established with a second computer 16 in the network 10 and a computer 16 in the network 14, which is marked with a broken line in FIG. 1. To be able to communicate between the computers 16, the firewalls 20, respectively, in each network 10, 12, 14, have to be forced. Of course, the computers 16 utilize protocols to force the firewalls, whereby data-headers within packets which are transmitted in the communication are correctly initialized for this purpose. Every network 10, 12, 14, has its own restrictions set for communication in the course of which files, how much data and the like, being allowed to be transmitted or received, which is controlled via the firewall 20.

Especially, through data security reasons, it is very hard to enforce a firewall 20 from the outside to the inside of a network 10, 12, 14, although legal information is contained in the data packets due to preset restrictions in firewalls 20. Hence, it is hard to communicate between networks 10, 12, 14 and their computers 16. For example, an employee in any of the companies, running the networks 10, 12, 14, is not able to accomplish relevant tasks regarding his employment from a home stationed PC, regarding the networks 10, 12, 14 with the restrictions concerning external traffic controlled by firewalls 20. Other example of restrictions, problems, and difficulties for a simple manifold data communication from and to networks 10, 12, 14 via firewall, socks, IP-filter, or proxy have been mentioned above in relation to the problem stand of the present invention, and is not specifically repeated here, but are well known to a person skilled in the art.

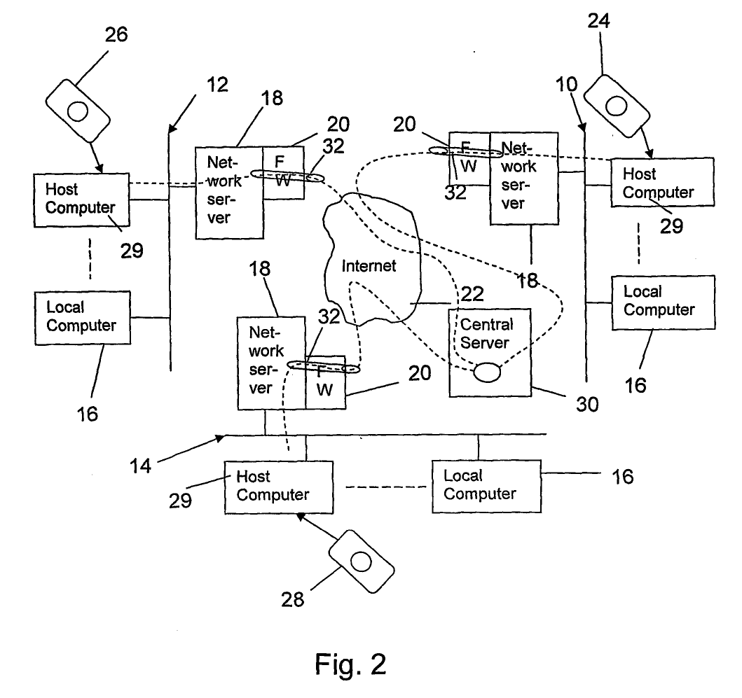

FIG. 2 schematically depicts how a network connection is established through tunneling according to the present invention. Depicted means in FIG. 1, corresponding to those in FIG. 2 are attached the same reference signs. To accomplish the network connection in accordance with the present invention a per se known storing medium 24, 26, 28 in the shape of any portable device, preferably in pocket shape, comprising electronic memory for storing software, and an interface to a computer in order to establish tunneling via a computer 16 through a firewall, socks, IP-filter, or proxy. Henceforth, a firewall 20 is utilized in exemplifying the invention, but a person skilled in the art understands that other access protection/security can be forced by the concept underlying the present invention, whereby these are comprised in accordance within the wording of the attached claims. The same is accounted for the storing medium, which is exemplified in the shape and size of a credit card, including a mini-CD storing space for comprised software. Other storage media usable in accordance with the present invention are for instance cellular phones, personal digital assistances (PDA), USB memories, and other known devices for a person skilled in the art. The interface towards computer 16, in one embodiment of the invention, consists of a CD-slot, -slide, when relating to the mini-CD card 24, 26, 28, and wire or wireless transmission between computers and PDA's known to a person skilled in the art.

The storing medium, in accordance with one embodiment of the present invention, comprises a graphical user interface (GUI) with drag & drop functionality, automatic access without the user needing to know about IP addresses and the handling of them. The storing medium 25, 26, 28, has a client-server-software, where the client depends on the medium 24, 26, 28, whereby the medium in one embodiment as a card, having the size of a credit card has a CD-disc imprinted in the format of a FlexDisc-CD®. The card Comprising the CD-disc functions as a key and is placed in a CD-slot. Software comprised on the CD-disc enables a user to transparently work through firewalls and proxies through the present invention. The present invention does not leave any traces on the computers utilized for access to a network connection.

Facts regarding the media in one embodiment:
Simple file sharing without web-reader
2048 encryption
Automatic file synchronization
Company folder (intranet)
Unique password protected network folder (extranet)
Firewall friendly, FTP with only two ports, tunneling through HTTP, HTTPS sockets
Own inbox, receiving files through e-mail
Mails files through SSL links
Supports portable CD-media utilization
Multi windows for multiple open accounts

To be able to utilize the present invention, a handhold network connection is utilized created comprising at least two storage mediums 24, 26, 28 in pocket size, with software for communicating data packets between at least two networks 10, 12, 14. Through the software on the card 24, 26, 28, a communication is established with the host computer 29 within the company network 10, 12, 14, by borrowing its temporary files, which provides access to the host computer 29, without disturbing/tresspassing the file structure of the host computer.

In order to provide the before mentioned, a crypto-daemon is utilized (software), which comprises an access methodic, which tests to establish a tunneling through the access blockage 20 towards a central server 30, regarding the type of allowed data packets for communication towards existing types of access blockage 20. The crypto-daemon establishes the tunneling 32, herein schematically depicted as tube shaped through the firewall 20 in FIG. 2, towards the central externally, for the networks 10, 12, 14, situated server 30, through the access blockage 20 via a test establishment of a communication with the access blockage 20. The tunneling 32 in FIG. 2 is depicted by broken lines, and in the central server 32, a circle shaped memory space has been provided as a node for communication between users of the storage medium 24, 26, 28. The memory space is not limited in size, and here different owners of the storage medium 24, 26, 28, can have an account for file storage and other transactions between mediums 24, 26, 28.

The server, according to one embodiment of the present invention, has the following features in one embodiment:
Written in ANSI C/C++
Support for Qouta
Able to distribute UNIX/HFS+filesystems
LINUX/Solaris/BSD compatible
Minimizes network loads
Protection against hacker exposure, and minimal expose towards the network

Moreover, the medium 24, 26, 28, has the following client features:
32 bits Windows-program
Win95/98/MEI2000/NT/XP-compatible
No installation
Configurable user interface
Drag & drop
Automatic start
Support for any file format
Only outbound traffic from the client

The access methodic adapts to the requested type of data packets by repetitively asking the access blockage for the allowed type of data packets. This is provided until the correct type is encountered through the memory of the methodic repetitively discarding wrongly performed requests, and by a correct request changing the data packets structure to a requested structure for the specific port in question for a communication.

With the methodic in the daemon an external network is established via the external central server 30 situated outside the networks 10, 12, 14 for simultaneous communication through at least two storage mediums 24, 26, 28 and its software. Hereby, tunneling is accomplished through the access blockage 20, without interfering the network 10, 12, 14 per se, establishing free capacity towards the access blockage 20 for the communication of data packets.

Access Methodic

An example is now provided herein of a possible access methodic according to the present invention. Ports that can be open through proxies/firewalls are provided by:
FTP (21)
SSH (22)
Telnet (23)
SMTP (80)
POP3 (110) (incoming mail)
Traceroute (443)
   There exist further ports, but those are the most probable. Of these, ports 80 and 443 are with great probability open through firewalls for instance to make surfing on the net possible. On the other hand there are many proxies, which only allow traffic towards port 443. In the methodic according to the present embodiment port 443 is utilized, due to the above, and also due to that data transmitted is supposed to be encrypted.

The modus operandus is stated here as pseudo-code for access to port 443:

Check if proxy is to be utilized

If “OK”

Test HTTP-proxy
If “OK”

Connect through proxy

Else

Test SOCKS4-proxy
If “OK”

Connect through SOCKS4-proxy

Else

Test SOCKS5-proxy
If “OK”

Connect through SOCKS5-proxy

Else

Test direct connection
If “OK”

Provide direct connection

Else

Direct connection failure

Else

Test direct connection

If “OK”

Provide direct connection

Else

Connection failure or test new port.

Moreover, comprised in the methodic, in a future, if future generations of proxies/firewalls only lets acknowledged traffic pass, for example, HTML-code, this can be surrounded by hiding transmitted data by transmitting a dummy HTML-page with the data masked as a picture or the like. A further alternative in a methodic is to test access via other ports than 443 if that should fail.

The present invention provides that files are accessed via the host computers 29 temporary file catalogue. From there they are positioned encrypted on the external central server 30 with a predetermined access profile, which at least provides reading of a file, but not copying from a computer outside the network, having the host computer 29 connected, which allows display/showing of files outside the network.

The media 24, 26, 28 provides that their users are able to freely move in a foreign/unknown network 10, 12, 14, to a user, and to externally communicate via the external central server 30 with other users of the media via the tunneling 32. Furthermore, in one embodiment, the media 24, 26, 28 software comprises IP telephony, whereby a user of the media from an arbitrary computerized 16, 29 device in an arbitrary network 10, 12, 14 is able to establish spontaneous IP telephony via the external central server 30.

The present invention enables the creation of at least one of a radio channel and film channel with other users in the external network, through the media 24, 26, 28 software comprising streaming media, whereby a user is able to consume music and film via tunneling 32.

Another advantage embodiment provides that the media software comprises version handling, which enables that earlier versions of files can be re-created by saving changes in a separate memory In the external central server 30, which Is switched on/off through a switch, on demand of a user.

Moreover, the software of the media 24, 26, 28 is in one embodiment adapted so that multiple users are enabled to process a common text-file in real-time through the external central server 30.

The present invention solves both the needs of a single employee and a companies need for an immediate backup, access to shared and private working space, and the establishment of efficient networks with new customers, companies or hired consultants. It immediately functions in an existing infrastructure.

The easy mobility, possibility to work on any computer probably will encourage that more persons choose to carry storage media utilized in accordance with the present invention instead of utilizing heavy laptop-computers. Usage and costs for portable machines is reduced. The pressure on a system administrator is reduced, as such a person will be able to distribute cards to newly employed, consultants, customers, and associates/colleagues, who instantly need working space, intranet, extranet, and e-mail. The storage media is a group tool, which can be handed out at a meeting without planning, and where all involved are given access to a common working space, and an own working space with its own e-mail box.

Risks' relating to unauthorized persons stealing information from a company is reduced when the present invention is utilized. It is safe to handle files in accordance with the present invention, only password and account has to be memorized.

In accordance with the present invention, it enables clercs, receptionists, which are hired to transmit and receive huge files from the Internet for a company and its employees, to manage to do this with the computer at hand. They no longer have to send data through CD, Syqest, diskettes, portable hard discs, post, delivery, taxi and the like. Costs for this are now reduced.

The invention according to the present concept has enabled that VPN companies can afford to distribute storage media to those who are favored by it, without having to contemplate the cost per license or to employ a system administrator to install complex licenses. Reliance to complex and costly software systems for groupware users is no more required. Furthermore, the present invention establishes that every person in a company receives a backup. When losing data at work, the employees are able to fetch lost files from there accounts, and little time has been lost. If the company computers have been stolen or destroyed, the employee immediately can work on any computer, having an Internet connection to restore/fetch the lost files. Personnel no longer have to wait for the aid of “sysadmin” to manage to share files in a new project.

The simplicity in the solution and the low costs per client makes he present invention to an efficient tool to establish an infrastructure for a company or an organization. A salesman in a company, which uses the present invention, can arrive to a customer company and immediately work on any PC available to the salesman in the foreign/unknown infrastructure.

The ability to move between different working-groups, companies, home, spare time, and always be able to have access to files creates confidence for a salesman, private person or the like, when undertaking a business travel or when they change premises. The “horror” of having forgotten the files at the office when traveling is reduced through the concept of the present invention.

The present invention is not limited to given embodiments or examples. It is the attached set of claims that define possible further embodiments for a person skilled in the art.

1. A handheld network connection created with at least two storage media in pocket format, with software for communication of data packets between at least two network access blockages of the type of at least one of a firewall, socks, IP-filter and proxy, comprising:
each said storage media having an interface to a host computer in said networks, and which through software establishes communication with said host computer within said networks by utilizing said host computers temporary catalogues which provides access to said host computer without disturbing its file structure;
a crypto-daemon which comprises a connecting methodic testing to establish a tunneling to an external central server regarding the type of the allowable data packets for communication towards the existing type of access blockage, said crypto-daemon establishing said tunneling towards said external central server passing said access blockage through a test establishment of a communication with said access blockage, said connecting methodic adapting to the wanted type of data packets by repeatedly questioning said access blockage for the allowable type of data packages until the correct type is encountered by remembering and repeatedly disregarding wrong questionings, and at the correct questioning changing the structure of the data package to the wanted structure for the specific port at hand for a communication; and
whereby an external network is established through said external central server outside said networks for simultaneous communication through at least two storage media and their software, said tunneling through said access blockage being provided without trespassing said networks per se, conveying towards said access blockage unrestricted capacity for said communication of data packets.

2. A network connection according to claim 1, wherein said methodic addresses the following software expressed in pseudo code while accessing a determined port:
check if proxy is to be utilized
If “OK”
Test HTTP-proxy
If “OK”
Connect through proxy
Else
Test SOCKS4-proxy
If “OK”
Connect through SOCKS4-proxy
Else
Test SOCKS5-proxy
If “OK”
Connect through SOCKS5-proxy
Else
Test direct connection
If “OK”
Provide direct connection
Else
Direct connection failure
Else
Test direct connection
If “OK”
Provide direct connection
Else
Connection failure or test new port.

3. A network connection according to claim 1, wherein said methodic comprising for a future generation of proxy/firewall, only letting through granted traffic is overruled by hiding transmitted data through a dummy HTML page with said data masked.

4. A network connection according to claim 1, wherein accessible files through said host computer are fetched and encoded in the host computer temporary file catalogue, said files being stored encoded on the external central server, having a determined access profile allowing at least reading of said file but not copying from a computer outside the network with a connected host computer, thus allowing display of files outside said network.

5. A network connection according to claim 1, wherein said media allows its user to freely move in a host network and to communicate externally through said external central server with other users of the media through said tunneling.

6. A network connection according to claim 1, wherein said media software comprises IP-telephony, said user of the media from a computerized device of his choice in a network of his choice establishing spontaneous IP-telephony through said central server.

7. A network connection according to claim 1, wherein a creation of at least one of a radio channel and a film channel with other users in said external network is enabled by said media software, comprising streaming media, said users thus being able to consume music and film.

8. A network connection according to claim 1, wherein said media software comprises version handling, thus making possible to recreate earlier versions of files by saving changes in a separate memory in said external central server, being switched on/off through a server switch on the request of a user.

9. A network connection according to claim 1, wherein said media software enables multiple users of it to process a common text file in real time through said external central server.

10. A method for a handheld network connection created with at least two storage media in pocket format, with software for communication of data packets between at least two network access blockages of the type of at least one of a firewall, socks, IP-filter and proxy, comprising the steps of:
each said storage media having an interface to a host computer in said networks, and which through software establishes communication with said host computer within said networks by utilizing said host computers temporary catalogues which provides access to said host computer without disturbing its file structure;
having an access methodic comprised in a crypto-daemon testing to establish a tunneling to an external central server regarding the type of the allowable data packets for communication towards the existing type of access blockage, said crypto-daemon establishing said tunneling towards said external central server passing said access blockage through a test establishment of a communication with said access blockage, said connecting methodic adapting to the wanted type of data packets by repeatedly questioning said access blockage for the allowable type of data packages until the correct type is encountered by remembering and repeatedly disregarding wrong questionings, and at the correct questioning changing the structure of the data package to the wanted structure for the specific port at hand for a communication; and
whereby an external network is established through said external central server outside said networks for simultaneous communication through at least two storage media and their software, said tunneling through said access blockage being provided without trespassing said networks per se, conveying towards said access blockage unrestricted capacity for said communication of data packets.

11. A method according to claim 10, wherein said methodic addresses the following software expressed in pseudo code while accessing a determined port:
check if proxy is to be utilized
If “OK”
Test HTTP-proxy
If “OK”
Connect through proxy
Else
Test SOCKS4-proxy
If “OK”
Connect through SOCKS4-proxy
Else
Test SOCKS5-proxy
If “OK”
Connect through SOCKS5-proxy
Else
```
Test direct connection
If “OK”
  Provide direct connection
Else
  Direct connection failure
```
Else
Test direct connection
If “OK”
Provide direct connection
Else
Connection failure or test new port.

12. A method according to claim 10, wherein said methodic comprising for a future generation of proxy/firewall, only letting through granted traffic is overruled by hiding transmitted data through a dummy HTML page with said data masked.

13. A method according to claim 10, wherein accessible files through said host computer are fetched and encoded in the host computer temporary file catalogue, said files being stored encoded on the external central server, having a determined access profile allowing at least reading of said file but not copying from a computer outside the network with a connected host computer, thus allowing display of files outside said network.

14. A method according to claim 10, wherein said media allows its user to freely move in a host network and to communicate externally through said external central server with other users of the media through said tunneling.

15. A method according to claim 10, wherein said media software comprises IP-telephony, said user of the media from a computerized device of his choice in a network of his choice establishing spontaneous IP-telephony through said central server.

16. A method according to claim 10, creating at least one of a radio channel and a film channel together with other users in said external network by said media software, comprising streaming media, said users thus being able to consume music and film.

17. A method according to claim 10, wherein said media software comprises version handling, thus making possible to recreate earlier versions of files by saving changes in a separate memory in said external central server, being switched on/off through a server switch on the request of a user.

18. A method according to claim 10, wherein said media software enables multiple users of it, to process a common text file in real time through said external central server.
